(19) United States
(12) Patent Application Publication
(10) Pub. No.: US 2009/0207140 A1
(43) Pub. Date: Aug. 20, 2009

(54) IDENTIFYING AND RESPONDING TO MULTIPLE TIME-OVERLAPPING TOUCHES ON A TOUCH PANEL

(75) Inventor: Per-Ragnar Hansson, Stockholm (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/033,405

(22) Filed: Feb. 19, 2008

(51) Int. Cl. G06F 3/041

(52) U.S. Cl. 345/173

(57) ABSTRACT

An electronic device includes a touch panel interface that receives information from a touch panel indicating sensed movement between two user touch positions on the touch panel, and identifies that at least two time-overlapping touches have occurred at different positions on the touch panel in response to at least a threshold speed of the movement. The touch panel interface identifies that at least two time-overlapping touches have occurred on the touch panel in response to a speed of movement from one touch coordinate position to another exceeding the threshold speed. The touch panel interface also identifies that a single touch has occurred with subsequent sliding while pressed against the touch panel from one touch coordinate position to another in response to the movement having less than the threshold speed. Because the touch panel controller can distinguish between a single touch and at least two time-overlapping touches, it can enable a user to use various combinations of such touches to trigger different operational modes of the electronic device.

### FIELD OF THE INVENTION

This invention relates to user interfaces for electronic devices, and more particularly to touch panel interfaces for electronic devices such as wireless communication terminals.

### BACKGROUND OF THE INVENTION

Touch panels and, more particularly, touch screens are becoming a popular interface on electronic devices for users to enter commands and data used in the operation of the device. Touch screens can now be found in mobile telephones, particularly cellular telephones having integrated PDA (personal digital assistant) features and other phone operation related features. The touch screens are generally designed to operate and respond to a finger touch, a stylus touch, or finger/stylus movement on the touch screen surface. Touch screens may be used in addition to, in combination with, or in place of physical keys traditionally used in a cellular phone to carry out the phone functions and features.

Touching a specific point on the touch screen display may activate a virtual button, feature, or function found or shown at that location on the touch screen display. Typical phone features which may be operated by touching the touch screen display include entering a telephone number, for example, by touching virtual keys of a virtual keyboard shown on the display, making a call or ending a call, bringing up, adding to or editing and navigating through an address book, and other phone functions such as text messaging, wireless connection to the global computer network, and other phone functions.

Commercial pressures to provide far more functionality within smaller physical device sizes is continuing to drive the need to develop even more versatile user interfaces.

### SUMMARY OF THE INVENTION

In some embodiments of the present invention, information is received from a touch panel that indicates movement between two user touch positions that are sensed on the touch panel. At least two time-overlapping touches are identified to have occurred at different positions on the touch panel in response to at least a threshold speed of the movement.

In some further embodiments, receiving of the information includes receiving a first touch coordinate position from the touch panel and receiving a second touch coordinate position from the touch panel appearing to be sliding movement of the touch position while pressed against the touch panel. The at least two time-overlapping touches are identified to have occurred on the touch panel in response to a speed of movement from the first touch coordinate position to the second touch coordinate position exceeding the threshold speed.

In some further embodiments, the determination finds that a single touch with subsequent sliding has occurred while pressed against the touch panel from the first touch coordinate position to the second touch coordinate position in response to the movement having less than the threshold speed.

In some further embodiments, a display slider mode is activated in response to identification of the at least two time-overlapping touches on the touch panel. While the display slider mode is active, a response to further movement of the user touch position on the touch panel includes scrolling an image to be displayed on a display device in the direction of the further movement.

In some further embodiments, a display zoom mode is activated in response to identification of the at least two time-overlapping touches on the touch panel. While the display zoom mode is active, a response to further movement of the user touch position on the touch panel includes zooming in/out size of an image to be displayed on a display device.

In some further embodiments, a fast-forward and/or reverse option play mode is activated in response to identification of the at least two time-overlapping touches on the touch panel, and a response to further movement of the user touch position on the touch panel in a first direction includes speeding-up playing of audio/video data to a user, and a response to further movement of the user touch position on the touch panel in a different second direction includes backing-up playing of audio/video data to a user.

In some further embodiments, a response to identification of the at least two time-overlapping touches on the touch panel and to further movement of the user touch position on the touch panel includes scrolling through an application interface menu to be displayed on a display device in the direction of the further movement.

In some other embodiments, an electronic device includes a touch panel interface that is configured to receive information from a touch panel indicating sensed movement between two user touch positions on the touch panel, and to identify that at least two time-overlapping touches have occurred at different positions on the touch panel in response to at least a threshold speed of the movement.

In some further embodiments, the electronic device further includes a touch panel that outputs a series of touch coordinate positions to the touch panel interface in response to continued touching of the touch panel, wherein the touch panel interface identifies that at least two time-overlapping touches have occurred on the touch panel in response to a speed of movement from a first one of the touch coordinate positions to a second one of the touch coordinate positions exceeding the threshold speed.

In some further embodiments, the touch panel interface is further configured to identify that a single touch has occurred with subsequent sliding while pressed against the touch panel from the first touch coordinate position to the second touch coordinate position in response to the movement having less than the threshold speed.

In some further embodiments, the touch panel interface includes a touch coordinate circuit and a multiple touch detector circuit. The touch coordinate circuit is configured respond to the information indicating touching of the touch panel by generating digital touch coordinate position values indicating a coordinate position where the touch panel is touched. The multiple touch detector circuit is configured to identify that at least two time-overlapping touches have occurred on the touch panel in response to a speed of movement from a first one of the touch coordinate positions to a second one of the touch coordinate positions exceeding the threshold speed, and to identify that a single touch has occurred with subsequent sliding while pressed against the touch panel from the first touch coordinate position to the second touch coordinate position in response to the movement having less than the threshold speed.

In some further embodiments, the touch panel includes a resistive touch panel that is configured to generate the series of touch coordinate positions as signals having voltage amplitudes that vary in response to different touched locations on the touch panel.

In some further embodiments, the touch panel includes a capacitive touch panel that is configured to generate a sinusoidal signal having characteristics that are modulated differently in response to different touched locations on the touch panel.

In some further embodiments, the electronic device further includes an application functionality controller that is configured to activate a display slider mode in response to identification of the at least two time-overlapping touches at different positions on the touch panel, and, while the mode is active, to respond to further movement of the user touch position on the touch panel by scrolling an image to be displayed on a display device in the direction of the further movement.

In some further embodiments, the electronic device further includes an application functionality controller that is configured to activate a display zoom mode in response to identification of the at least two time-overlapping touches at different positions on the touch panel, and, while the mode is active, to respond to further movement of the user touch position on the touch panel by zooming in/out size of an image to be displayed on a display device.

In some further embodiments, the electronic device further includes an application functionality controller that is configured to activate a fast-forward and reverse option play mode in response to identification of the at least two time-overlapping touches at different positions on the touch panel, and, while the mode is active, to respond to further movement of the user touch position on the touch panel in a first direction by speeding-up playing of audio/video data to a user and to respond to further movement of the user touch position on the touch panel in a different second direction by backing-up playing of audio/video data to a user.

In some further embodiments, the electronic device further includes an application functionality controller that is configured to respond to identification of the at least two time-overlapping touches at different positions on the touch panel and to further movement of the user touch position on the touch panel by scrolling through an application interface menu to be displayed on a display device in the direction of the further movement.

In some other embodiments, an electronic device includes a resistive touch panel, a touch coordinate circuit, a multiple touch detector circuit, and an application functionality controller. The resistive touch panel generates Touch coordinate position signals having voltage amplitudes that vary in response to different touched locations on the touch panel. The touch coordinate circuit responds to the touch coordinate position signals from the touch panel by generating digital touch coordinate position values indicating coordinate positions where the touch panel is touched. The multiple touch detector circuit identifies that at least two time-overlapping touches have occurred on the touch panel in response to a speed of movement from one touch coordinate position value to another exceeding a threshold speed value, and identifies that a single touch has occurred with subsequent sliding while pressed against the touch panel from the one touch coordinate position value to the other touch coordinate position value in response to the movement having less than the threshold speed. The application functionality controller responds to identification of the at least two time-overlapping touches at different positions on the touch panel by triggering different operational modes of the electronic device.

### BRIEF DESCRIPTION OF THE DRAWINGS

FIG. 1 is a block diagram of a touch panel interface that identifies multiple time-overlapping touches in accordance with some embodiments of the present invention.

FIG. 2 illustrates occurrence of a single touch with subsequent sliding while pressed against a touch panel which is detected using the touch panel interface of FIG. 1 in accordance with some embodiments of the present invention.

FIG. 3 illustrates occurrence of two time-overlapping touches at different positions on a touch panel which are detected using the touch panel interface of FIG. 1 in accordance with some embodiments of the present invention.

FIG. 4 illustrates occurrence of two time-overlapping touches at different positions on a touch panel with an additional third time-overlapping touch on the touch panel and which are detected using the touch panel interface of FIG. 1 in accordance with some embodiments of the present invention.

FIG. 5 illustrates occurrence of two time-overlapping touches at different positions on a touch panel with subsequent sliding while pressed against the touch panel and which are detected using the touch panel interface of FIG. 1 in accordance with some embodiments of the present invention.

FIG. 6 illustrates occurrence of two time-overlapping touches at different positions on a touch panel with subsequent sliding in different directions while pressed against the touch panel and which are detected using the touch panel interface of FIG. 1 in accordance with some embodiments of the present invention.

FIG. 7 is a block diagram of a wireless communications terminal including a touch panel controller and associated application functionality controller in accordance with some embodiments of the present invention.

FIG. 8 is a flowchart of operations that may be carried out by the touch panel controller of FIG. 1 and/or FIG. 7 to detect occurrence of multiple time-overlapping touches on a touch panel in accordance with some embodiments of the present invention.

### DETAILED DESCRIPTION OF PREFERRED EMBODIMENTS

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions may be exaggerated for clarity. Like numbers refer to like elements throughout.

Some embodiments may be embodied in hardware and/or in software (including firmware, resident software, micro-code, etc.). Consequently, as used herein, the term “signal” may take the form of a continuous waveform and/or discrete value(s), such as digital value(s) in a memory or register. Furthermore, various embodiments may take the form of a computer program product on a computer-usable or computer-readable storage medium having computer-usable or computer-readable program code embodied in the medium for use by or in connection with an instruction execution system. Accordingly, as used herein, the terms “circuit” and “controller” may take the form of digital circuitry, such as computer-readable program code executed by an instruction processing device(s) (e.g., general purpose microprocessor and/or digital signal processor), and/or analog circuitry.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Although various embodiments of the present invention are described in the context of wireless communication terminals for purposes of illustration and explanation only, the present invention is not limited thereto. It is to be understood that the present invention can be more broadly used in any sort of electronic device to identify and respond to multiple time-overlapping touches on a touch panel.

In accordance with some embodiments, an electronic device includes a touch panel controller that is configured to receive information from a touch panel indicating sensed movement between two user touch positions on the touch panel, and is further configured to identify that at least two time-overlapping touches have occurred at different positions on the touch panel in response to at least a threshold speed of the movement. The touch panel controller can distinguish between occurrence of a single touch on the touch panel with subsequent sliding between positions on the touch panel while pressed against the touch panel and occurrence of two time-overlapping touches at different positions on the touch panel. Because the touch panel controller can distinguish between a single touch and at least two time-overlapping touches, it can enable a user to use various combinations of such touches to trigger different operational modes of the electronic device.

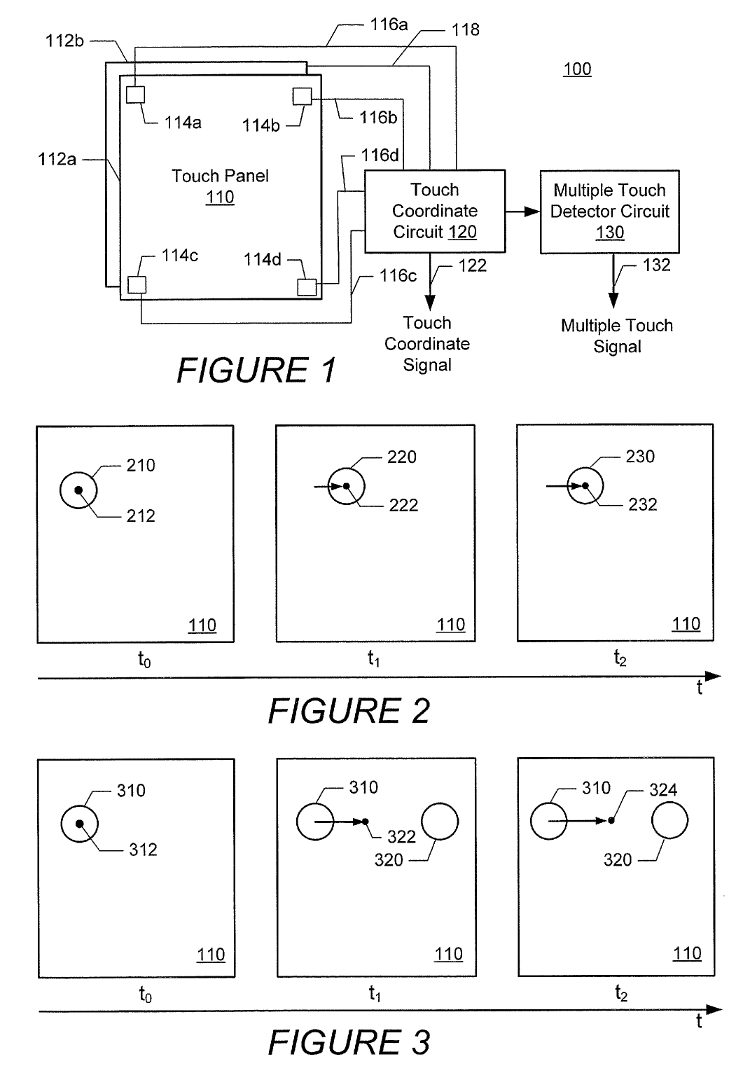

FIG. 1 is a block diagram of a touch panel interface 100 that identifies occurrence of at least two time-overlapping touches and can distinguish such multiple touches from a single touch with subsequent sliding. Referring to FIG. 1, interface 100 includes a touch panel 110, a touch coordinate circuit 120, and a multiple touch detector 130.

The touch panel 110 may be any type of touch sensitive interface that generates electrical signals which indicate a relative position where the panel was touched with, for example, a finger and/or a stylus. The touch panel 110 may be configured as a touch screen interface, such as by arranging a transparent/translucent touch panel across a display device (e.g., LCD or CRT display device).

The touch panel 110 may be a resistive touch panel that includes two thin metallic or other electrically conductive and resistive layers 112a-b separated by an insulated space and a plurality of conductive contacts 114a-d with connected wires 116a-c and 118. Touching one of the layers causes contact between the layers at the contact position and causes voltage signals at the conductive contacts that have magnitudes which vary based on the effective resistance between the contact position and the respective conductive contacts (i.e., differential voltages across respective combinations of the wires 118 and 116a-d). Accordingly, the relative magnitudes of the voltages between the wires 118 and 116a-d indicates the coordinate position where the touch panel 110 is touched. The touch panel 110 may additionally or alternatively be a capacitance touch panel that is configured to generate a sinusoidal signal having characteristics that are modulated differently in response to different touched locations on the touch panel.

The touch coordinate circuit 120 responds to voltage differences between the respective pairs of wires 118 and 116a-d to generate a touch coordinate signal 122 that identifies the coordinate position where the touch panel 110 is touched. The touch coordinate circuit 120 may be digital circuit that samples the voltage differences between the respective pairs of wires 118 and 116a-d to generate digital value(s) that indicate touch coordinate positions (e.g., X and Y coordinates). The multiple touch detector circuit 130 may include analog inductive circuitry that generates an output that is indicative of a time derivative of the change in voltage of the voltage signals between pairs of the lines 118 and 116a-d. The analog inductive circuitry may indicate that the speed of movement between touch positions exceeds a threshold speed when its time derivative output exceeds a threshold magnitude voltage.

Although FIG. 1 illustrates an exemplary touch panel, touch coordinate circuit, and multiple touch detector circuit, it will be understood that the present invention is not limited to such configurations, but is intended to encompass any configuration capable of carrying out at least one of the operational embodiments described herein.

FIG. 2 illustrates occurrence of a single touch with subsequent sliding while pressed against a touch panel and which is detected using the touch panel interface of FIG. 1 in accordance with some embodiments of the present invention. Referring to FIG. 2, at time t₀, a user touches the touch panel 110 with a finger at location 210. The touch coordinate circuit 120 receives electrical signals from the touch panel 110 and generates therefrom the touch coordinate signal 122 indicating a touch coordinate position 212. Following time t₀, the user slides the same finger across the touch panel 110 while pressing against the touch panel 110. Thus, at time t₁, the same finger is now located at position 220 and the touch coordinate signal 122 indicates a touch coordinate position 222. Furthermore, at time t₂, the same finger is now located at position 230 and the touch coordinate signal 122 indicates a touch coordinate position 232. Accordingly, as the user slides the same finger across the touch panel 110, the touch coordinate circuit 120 generates a sequence of touch coordinate positions, which, when the touch coordinate circuit 120 is a digital circuit, may be periodically generated at a sample rate of the voltage signals from the touch panel 110.

The multiple touch detector 130 is configured to identify when at least two time-overlapping touches have occurred at different positions on the touch panel 110 in response to whether the speed of movement of the touch positions is at least a threshold speed. The multiple touch detector 130 generates a multiple touch signal 132 that indicates occurrence of at least two time-overlapping touches on the touch panel 110.

Referring to the example touching of FIG. 2, the multiple touch detector 130 determines that the relatively slow speed of the movement from position 212 to position 222 and then to position 232 between corresponding times t₀, t₁, and t₂ is less than the threshold speed and, therefore, corresponds to occurrence of a single touch at position 212 and subsequent sliding to the positions 222 and 232. Accordingly, the multiple touch signal 132 from the multiple touch detector 130 does not indicate that two or more time-overlapping touches are occurring.

FIG. 3 illustrates occurrence of two time-overlapping touches at different positions on a touch panel which are detected using the touch panel interface 100 of FIG. 1. Referring to FIG. 3, at time t₀, a user touches the touch panel 110 with a finger at location 310. The touch coordinate circuit 120 receives electrical signals from the touch panel 110 and generates therefrom the touch coordinate signal 122 indicating a touch coordinate position 312. At time t₁, the user touches the touch panel 110 at position 320 while maintaining touching of the touch panel 110 at position 310, thereby resulting in two time-overlapping touches. The touch coordinate circuit 120 responds to changes in the electrical signals from the touch panel 110 by determining that the touch coordinate position is now at position 322, which may correspond to an abrupt movement over a substantial distance toward, or all the way to, a midpoint between the two time-overlapping touch positions 310 and 320. At time t₂, with the user continuing to touch at positions 310 in 320, the touch coordinate circuit 120 may sense that the touch coordinate position has continued to move further to position 322, which corresponds to a midpoint between the two time-overlapping touch positions 310 and 320.

The multiple touch detector 130 identifies that the movement from touch coordinate position 312 to touch coordinate position 322 over the time interval t₀-t₁ and/or from touch coordinate position 322 to touch coordinate position 324 over the time interval t₁-t₂ occurred at a speed that is greater than the threshold speed. The multiple touch detector 130 responds to identification of the higher-than-threshold speed by causing the multiple touch signal 132 to indicate that at least two time-overlapping touches are occurring on the touch panel 110.

Accordingly, the touch panel interface 100 can distinguish between the occurrence of a single touch on the touch panel 110 with subsequent sliding between positions and the occurrence of two time-overlapping touches at different positions on the touch panel 110. As will be explained in further detail below, the combination of the multiple touch signal 132 and the touch coordinate signal 122 can be used by other circuitry, such as by an application functionality controller, to enable a user to use various combinations of such touches to trigger different operational modes of an electronic device.

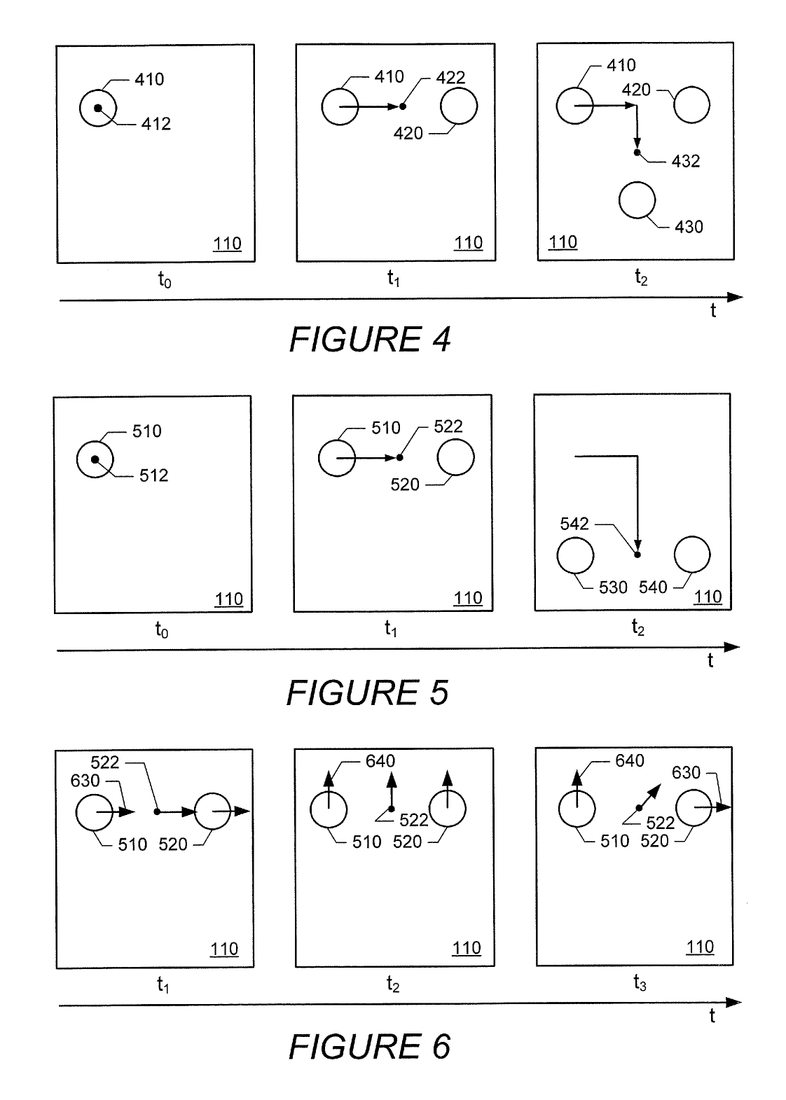

FIG. 4 illustrates occurrence of two time-overlapping touches at different positions on the touch panel 110 with an additional third time-overlapping touch on the touch panel 110 and which are detected using the touch panel interface 100 of FIG. 1. Referring to FIG. 4, at time to, a user touches the touch panel 110 with a finger at location 410 which causes the touch coordinate circuit 120 to indicate a touch coordinate position 412. At time t₁, the user touches the touch panel 110 at position 420 while maintaining touching at position 410, thereby resulting in two time-overlapping touches and causing the touch coordinate circuit 120 to indicate a touch coordinate position 422 (e.g., at a midpoint between the time-overlapping positions 410 and 420). The multiple touch detector 130 also responds thereto by identifying that two time-overlapping touches are occurring in response to the speed of the movement between touch coordinate positions 412 to 422.

At time t₂, with the user continuing to touch at positions 410 and 420, the user further touches the touch panel 110 at a third position 430, thereby resulting in three time-overlapping touches and causing the touch coordinate circuit 120 to indicate a touch coordinate position 432. The multiple touch detector 130 also responds by identifying that three time-overlapping touches are occurring in response to the speed of the movement of the touch coordinate position from 422 to 432.

The multiple touch detector 130 identifies that the movement from touch coordinate position 412 to touch coordinate position 422 over the time interval t₀-t₁ and/or from touch coordinate position 422 to touch coordinate position 432 over the time interval t₁-t₂ occurred at a speed that is greater than the threshold speed. The multiple touch detector 130 also responds thereto by identifying that three time-overlapping touches are occurring in response to the speed and sequence of different movements.

Accordingly, the touch panel interface 100 can further distinguish between occurrence of two time-overlapping touches and three time-overlapping touches at different positions on the touch panel 110. The combination of the multiple touch signal 132 and the touch coordinate signal 122 can be used by other circuitry, such as by an application functionality controller, to enable a user to use various combinations of such touches to trigger different operational modes of an electronic device.

FIG. 5 illustrates occurrence of two time-overlapping touches at different positions on the touch panel 110 with subsequent sliding while pressed against the touch panel 100 and which are detected using the touch panel interface 100 of FIG. 1. Referring to FIG. 5, at time t₀, a user touches the touch panel 110 with a finger at location 510 which causes the touch coordinate circuit 120 to indicate a touch coordinate position 512. At time t₁, the user touches the touch panel 110 at position 520 while maintaining touching at position 510, thereby resulting in two time-overlapping touches and causing the touch coordinate circuit 120 to indicate a touch coordinate position 522. The multiple touch detector 130 also responds thereto by identifying that two time-overlapping touches are occurring in response to the speed of the movement between touch coordinate positions 512 to 522.

At time t₂, the user simultaneously slides the touching fingers downward to positions 530 and 530 while pressing on the touch panel 110, thereby causing the touch coordinate circuit 120 to correspondingly change the touch coordinate position downward to position 542. Because of the slower movement speed from the touch position 522 to position 542, the multiple touch detector 130 does not identifying that movement as corresponding to a third or more time-overlapping touches.

Accordingly, the touch panel interface 100 identified that two time-overlapping touches occurred with subsequent sliding downward to position 542, and controlled the multiple touch signal 132 and the touch coordinate signal 122 to indicate occurrence of the identified touches and relative positions over time.

FIG. 6 illustrates occurrence of two time-overlapping touches at different positions on the touch panel 110 with subsequent sliding in different directions while pressed against the touch panel 100 and which are detected using the touch panel interface 100 of FIG. 1. Referring to FIG. 6, just before time t₁, a user has sequentially touched the touch panel 110 at locations 510 and 520 to provide two time-overlapping touches (e.g., the touches occurring at time t₁ of FIG. 5), and which caused the touch coordinate circuit 120 to indicate a touch coordinate position 522. At time t₁ the user begins sliding the touching fingers in a horizontal direction 630, which causes the multiple touch signal 132 to indicate that two time-overlapping touches are occurring and the touch coordinate signal 122 changes over time to indicate that the touch coordinate position 522 is moving in the horizontal direction 630. At time t₂ the user begins sliding the touching fingers in a vertical direction 640, thereby causing the multiple touch signal 132 to indicate that two time-overlapping touches are occurring while the touch coordinate signal 122 indicates that the touch coordinate position 522 is moving in the vertical direction 640. At time t₃ the user begins sliding one of the touching fingers in the vertical direction 640 and sliding the other touching finger in the horizontal direction 630, which causes the multiple touch signal 132 to indicate that two time-overlapping touches are occurring while the touch coordinate signal 122 indicates that the touch coordinate position 522 is moving in both of the directions 640 and 630. The touch coordinate position 522 may track the X and Y coordinates of the touch coordinate position 522 as it moves across the touch panel 110.

Accordingly, the touch panel interface 100 can further identify and output an indication of when two or more time-overlapping touches are occurring with the touch positions moving in different directions, which can be used by other circuitry to enable a user to use various combinations of such touches to trigger different operational modes of an electronic device.

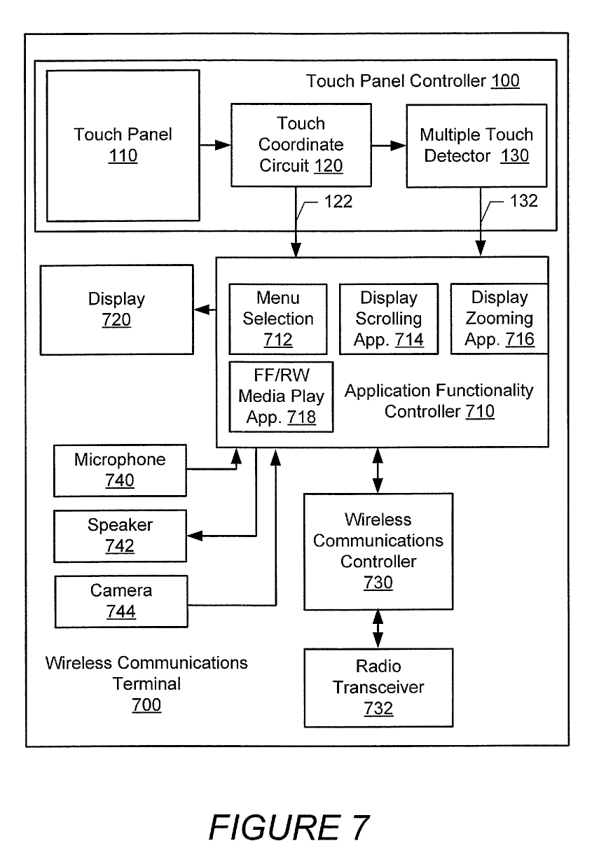

FIG. 7 is a block diagram of a wireless communications terminal 700 that includes the touch panel interface 100 of FIG. 1 which identifies various combinations of the above-described touches on the touch panel 110 to trigger different operational modes. Referring to FIG. 7, the wireless communication terminal 700 further includes an application functionality controller 710, a display 720, a wireless communications controller 730, a radio transceiver 732, a microphone 740, and a speaker 742.

The wireless communications controller 730 is configured to communicate through the radio transceiver 732 over a wireless air interface with one or more RF transceiver base stations and/or other wireless communication devices using one or more wireless communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, Universal Mobile Telecommunications System (UMTS), WiMAX, and/or HIPERMAN, wireless local area network (e.g., 802.11), and/or Bluetooth.

The wireless communications controller 730 may be configured to carry out wireless communications functionality, such as conventional cellular phone functionality including, but not limited to, voice/video telephone calls and/or data messaging such as text/picture/video messaging.

The application functionality controller 710 is configured to provide various user applications which can include a music/picture/video recorder/player application, an e-mail/messaging application, a calendar/appointment application, and/or other user applications. The music/picture/video recorder/player application can be configured to record and playback music, digital pictures, and/or movies that are captured by a sensor (e.g., microphone 740 and/or camera 744) within the terminal 700, downloaded into the terminal 700 via the radio transceiver 732 and the wireless communications controller 730, downloaded into the terminal 700 via a wired connection (e.g., via USB), and/or installed within the terminal 700 such as through a removable memory media. The e-mail/messaging application can be configured to allow a user to generate e-mail/messages (e.g., short messaging services messages and/or instant messages) for transmission via the wireless communications controller 730 and the radio transceiver 732. The calendar/appointment application may provide a calendar and task schedule that can be viewed and edited by a user to schedule appointments and other tasks.

The application functionality controller 710 includes further applications that respond to the touch coordinate signal 122 and the multiple touch signal 132 from the touch panel controller 100 to control operation of one or more of the other applications within the terminal 700.

A menu selection application 712 can respond to identification of at least two time-overlapping touches on the touch panel 100 (i.e., via the multiple touch signal 132) by displaying certain menu options on the display 720. The menu selection application 712 can respond to further movement of the time-overlapping user touch positions on the touch panel 110 by scrolling through the displayed menu options in the direction of the further movement. Thus, in response to the events of FIG. 3, the menu selection application 712 can cause a user selectable menu for an application to be displayed on the display 720. Moreover, in response to the events of FIG. 6 and, in particular those at time t₂, the menu selection application 712 can cause the items that are displayed in the menu to be scrolled upward.

A display scrolling application 714 can respond to identification of at least two time-overlapping touches on the touch panel 100 and further movement of the time-overlapping user touch positions by causing the information that is displayed by an application on the display 720 to be scrolled in the direction of the further movement. Thus, in response to the events of FIG. 3, the menu selection application 712 can cause a user selectable scrollbar(s) for an application to be displayed on the display 720 (e.g., along a side and bottom of the display). Moreover, in response to the events of FIG. 6 and, in particular those at time t₂, the display scrolling application 714 can cause the information that is displayed to be scrolled upward, and in response to the events at times t₁ and t₃ in FIG. 5 can cause information that is displayed to be scrolled to the right and diagonally upward, respectively.

A display zooming application 716 can respond to identification of at least two time-overlapping touches on the touch panel 100 and further movement of the time-overlapping user touch positions by causing the information that is displayed by an application on the display 720 to be scaled in size based on the direction of the further movement. Thus, in response to the events of FIG. 3, the menu selection application 712 can cause a display zoom mode for an application to be activated. Moreover, in response to the events of FIG. 6 and, in particular those at time t₁, the display zooming application 716 can cause the information that is displayed to be zoomed-in (enlarged in size), and in response to the events at time t₂ in FIG. 5 can cause the information that is displayed to be zoomed-out (reduced in size).

A fast-forward (FF) and rewind (RW) media play application 718 can respond to identification of at least two time-overlapping touches on the touch panel 100 by activating a FF and FW mode in an application that plays audio/picture/video information in response to identification of the at least two time-overlapping touches at different positions on the touch panel. The FF and RW media play application 718 can respond to further movement of the time-overlapping user touch positions by causing the audio/picture/video information that is displayed by an application on the display 720 to be fast forwarded and reversed backward in time in response to the direction of the further movement. Thus, in response to the events of FIG. 3, the play FF and RW application 718 can cause a user selectable FF and RW button(s)/scrollbar(s) to be displayed on the display 720. Moreover, in response to the events of FIG. 6 and, in particular those at time t₁, the play FF and RW application 718 can cause the played audio/picture/video information to be fast forwarded and in response to movement in the opposite direction (opposite to 630) can cause the played information to be backed-up in time.

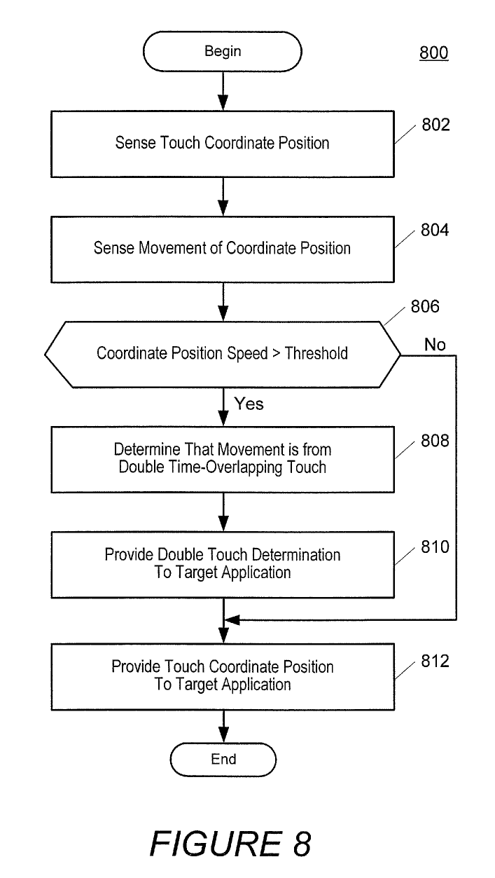

FIG. 8 is a flowchart of operations 800 that may be carried out by the touch panel interface 100 of FIG. 1 and/or FIG. 7 to detect occurrence of multiple time-overlapping touches on the touch panel 110 in accordance with some embodiments of the present invention. Referring to FIG. 8, touch coordinate position are sensed at block 802 from signals received from the touch panel 110. Movement between the different touch coordinate positions is sensed at block 804. A determination is made at block 806 as to whether the speed of the movement between the touch coordinate positions is greater than a speed threshold. In the movement speed is greater than the speed threshold, a determination is made at block 808 that at least two time-overlapping touches are occurring on the touch panel 110. A signal or other indication is provided at block 810 to a target application, such as to one or more of the above-described applications of application functionality controller 710, which indicates that at least two time-overlapping touches are occurring on the touch panel 110. At block 812, the coordinate positions of the touches may also be provided to the target application.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method comprising:
receiving information from a touch panel indicating movement between two user touch positions sensed on the touch panel, and
identifying that at least two time-overlapping touches have occurred at different positions on the touch panel in response to at least a threshold speed of the movement.

2. The method of claim 1, wherein:
receiving information comprises:
receiving a first touch coordinate position from the touch panel; and
receiving a second touch coordinate position from the touch panel appearing to be sliding movement of the touch position while pressed against the touch panel; and
identifying that at least two time-overlapping touches have occurred on the touch panel comprises:
identifying that the at least two time-overlapping touches have occurred on the touch panel in response to a speed of movement from the first touch coordinate position to the second touch coordinate position exceeding the threshold speed.

3. The method of claim 1, further comprising:
identifying that a single touch has occurred with subsequent sliding while pressed against the touch panel from the first touch coordinate position to the second touch coordinate position in response to the movement having less than the threshold speed.

4. The method of claim 1, further comprising:
activating a display slider mode in response to identification of the at least two time-overlapping touches on the touch panel.

5. The method of claim 4, further comprising:
while the display slider mode is active, responding to further movement of the user touch position on the touch panel by scrolling an image to be displayed on a display device in the direction of the further movement.

6. The method of claim 1, further comprising:
activating a display zoom mode in response to identification of the at least two time-overlapping touches on the touch panel.

7. The method of claim 6, further comprising:
while the display zoom mode is active, responding to further movement of the user touch position on the touch panel by zooming in/out size of an image to be displayed on a display device.

8. The method of claim 1, further comprising:
activating a fast-forward and/or reverse option play mode in response to identification of the at least two time-overlapping touches on the touch panel, and responding to further movement of the user touch position on the touch panel in a first direction by speeding-up playing of audio/video data to a user, and responding to further movement of the user touch position on the touch panel in a different second direction by backing-up playing of audio/video data to a user.

9. The method of claim 1, further comprising:
responding to identification of the at least two time-overlapping touches on the touch panel and to further movement of the user touch position on the touch panel by scrolling through an application interface menu to be displayed on a display device in the direction of the further movement.

10. An electronic device comprising:
a touch panel interface that is configured to receive information from a touch panel indicating sensed movement between two user touch positions on the touch panel, and to identify that at least two time-overlapping touches have occurred at different positions on the touch panel in response to at least a threshold speed of the movement.

11. The electronic device of claim 10, further comprising a touch panel that outputs a series of touch coordinate positions to the touch panel interface in response to continued touching of the touch panel, wherein the touch panel interface identifies that at least two time-overlapping touches have occurred on the touch panel in response to a speed of movement from a first one of the touch coordinate positions to a second one of the touch coordinate positions exceeding the threshold speed.

12. The electronic device of claim 10, wherein the touch panel interface is further configured to identify that a single touch has occurred with subsequent sliding while pressed against the touch panel from the first touch coordinate position to the second touch coordinate position in response to the movement having less than the threshold speed.

13. The electronic device of claim 10, wherein the touch panel interface comprises:
a touch coordinate circuit that is configured respond to the information indicating touching of the touch panel by generating digital touch coordinate position values indicating a coordinate position where the touch panel is touched; and
a multiple touch detector circuit that is configured to identify that at least two time-overlapping touches have occurred on the touch panel in response to a speed of movement from a first one of the touch coordinate positions to a second one of the touch coordinate positions exceeding the threshold speed, and to identify that a single touch has occurred with subsequent sliding while pressed against the touch panel from the first touch coordinate position to the second touch coordinate position in response to the movement having less than the threshold speed.

14. The electronic device of claim 10, wherein the touch panel comprises a resistive touch panel that is configured to generate the series of touch coordinate positions as signals having voltage amplitudes that vary in response to different touched locations on the touch panel.

15. The electronic device of claim 10, wherein the touch panel comprises a capacitive touch panel that is configured to generate a sinusoidal signal having characteristics that are modulated differently in response to different touched locations on the touch panel.

16. The electronic device of claim 10, further comprising an application functionality controller that is configured to activate a display slider mode in response to identification of the at least two time-overlapping touches at different positions on the touch panel, and, while the mode is active, to respond to further movement of the user touch position on the touch panel by scrolling an image to be displayed on a display device in the direction of the further movement.

17. The electronic device of claim 10, further comprising an application functionality controller that is configured to activate a display zoom mode in response to identification of the at least two time-overlapping touches at different positions on the touch panel, and, while the mode is active, to respond to further movement of the user touch position on the touch panel by zooming in/out size of an image to be displayed on a display device.

18. The electronic device of claim 10, further comprising an application functionality controller that is configured to activate a fast-forward and reverse option play mode in response to identification of the at least two time-overlapping touches at different positions on the touch panel, and, while the mode is active, to respond to further movement of the user touch position on the touch panel in a first direction by speeding-up playing of audio/video data to a user and to respond to further movement of the user touch position on the touch panel in a different second direction by backing-up playing of audio/video data to a user.

19. The electronic device of claim 10, further comprising an application functionality controller that is configured to respond to identification of the at least two time-overlapping touches at different positions on the touch panel and to further movement of the user touch position on the touch panel by scrolling through an application interface menu to be displayed on a display device in the direction of the further movement.

20. An electronic device comprising:
a resistive touch panel that is configured to generate touch coordinate position signals having voltage amplitudes that vary in response to different touched locations on the touch panel;
a touch coordinate circuit that is configured respond to the touch coordinate position signals from the touch panel by generating digital touch coordinate position values indicating coordinate positions where the touch panel is touched;
a multiple touch detector circuit that is configured to identify that at least two time-overlapping touches have occurred on the touch panel in response to a speed of movement from one touch coordinate position value to another exceeding a threshold speed value, and to identify that a single touch has occurred with subsequent sliding while pressed against the touch panel from the one touch coordinate position value to the other touch coordinate position value in response to the movement having less than the threshold speed; and
an application functionality controller that is configured to respond to identification of the at least two time-overlapping touches at different positions on the touch panel by triggering different operational modes of the electronic device.
